(19) United States
(12) Patent Application Publication
(10) Pub. No.: US 2017/0249679 A1
(43) Pub. Date: Aug. 31, 2017

(54) SYSTEM AND METHOD OF FINDING LIVE SERVICE RESPONSE

(71) Applicant: Paul George, Raleigh, NC (US)

(72) Inventor: Paul George, Raleigh, NC (US)

(21) Appl. No.: 15/429,146

(22) Filed: Feb. 9, 2017

Related U.S. Application Data
(63) Continuation-in-part of application No. 15/052,968, filed on Feb. 25, 2016, now abandoned.

(51) Int. Cl. G06Q 30/06

(52) U.S. Cl. CPC G06Q 30/0611; G06Q 30/0625

(57) ABSTRACT

The present invention relates to a method for putting service providers in live contact with those in need of service providers by a system of live online bids with awards going to a limited number of bidders.

This application is a continuation-in-part of U.S. non-provisional application Ser. No. 15/052,968 filed on Feb. 25, 2016, incorporated herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

Field of the Invention

The present invention relates to a quick live response, service inquiry response in an online market place. In particular, it relates to a system whereby service providers are notified of a need and receive information to contact the inquirer live, based on a bid system, and wherein the responses received are timely.

Description of Related Art

Before people had access to the internet, there was Yellow Pages, that people used whenever they needed to find a service provider. Search engines replaced yellow pages as the go to place for all information. Using search engine is a good option when you are seeking information or to buy a well-known common product, as search engines only connects the user of the query with a list of websites and never really connects the user with the actual service provider. Moreover the burden of searching, reading through each website to make sure the website is relevant and finally initiating the contact with the service provider is placed on the user. On average it takes 20 minutes or more to do a search for a service provider, read through all the list of websites, choose the right provider and initiate the contact with them. A lot of time is also wasted contacting service providers who are not available or capable of solving the need of the user.

With smart phones now being accessible to the public, some platforms have come about that uses a method of categorization for the most common services such as plumber, cleaning service etc. These services are very limited because if the user has a need that is outside the list of categories that these platforms provide, then they are not able to find the service provider they need. Service providers does not have flexibility in choosing the type of leads they want to receive as service providers are put under one broad category. Moreover some of these platforms sell leads for a fixed price, a price which in many cases are not affordable for the service provider.

The service provider's field is also available with inquiries through advertising. In addition, since computers match advertisements and the like, the customer or user must still contact someone who may not even be available or interested in providing a given service. The time lag is frequently intolerable. In prior art systems, having a minimum number of bids is critical for performance and time is only dealt with once enough service providers are found (US patent application 2009/0327097). In addition, one must go through multiple pages to communicate what's needed. Service providers likewise have to constantly advertise and there is little or no control of who answers an advertisement, leading to inquiries that are wasteful for both the customer and the service provider. Matching a service provider with a customer is still in need of vast improvements. The art is still looking for something that makes it easy for customers to find the service provider they need at the same time provide the flexibility and affordability that service providers desire.

### BRIEF SUMMARY OF THE INVENTION

The present invention relates to a system and method for matching a customer in need of a service to a service provider, wherein the connection is made as a live connection rather than just as a pay per click or other type of advertisement based on matching keywords and a bid system. When a user has a service need, the user sends a computer inquiry using an app, website or a computer, and then appropriate service providers are contacted within a limited time. Then the service providers that are interested in the work can bid to the system for the right to be presented to the user.

Accordingly, in one embodiment, there is a method performed by a non-transitory machine storage medium of one or more computers comprising:
a) receiving from a user's online computing device a computer inquiry containing unstructured data including attachments, requiring a service provider;
b) identifying any keywords in the inquiry and matching them with a plurality of service providers based on the keywords selected by the service providers, in a database of the service providers on the one or more computers;
c) transmitting the inquiry to the matched service provider's computing device without identifying the online user, or the service provider to the user;
d) the computer receiving bids from the matched service providers, the computer programmed to only accept bids within a specified time, the bids from service providers interested in providing a service to the online user; and
e) selecting a limited number of matched service provider bidders based on a selected criteria, including the bid amount, before providing the selected bidders with information to make a live contact with the online user in order to provide the service.

In another embodiment, there is a non-transitory computer storage medium encoded with a computer program, the program comprising instructions that, when executed by a data processing apparatus, cause the data processing apparatus to perform operations comprising:
a) receiving from a user's online computing device a computer inquiry containing unstructured data including attachments, requiring a service provider;
b) identifying any keywords in the inquiry and matching them with a plurality of service providers based on the keywords selected by the service providers, in a database of the service providers on the one or more computers;
c) transmitting the inquiry to the matched service providers without identifying the online user or the service providers to the user;
d) receiving bids from the matched service providers within a specified time, the bids from service providers interested in providing a service to the online user; and
e) selecting a limited number of matched service provider bidders based on a selected criteria, including the bid, before providing the selected bidders with information to contact the online user in order to provide the service.

In one embodiment, it is a system comprising one or more computers and a non-transient machine readable storage medium coupled to the one or more computers, the medium having encoded thereon instructions which, when executed by the one or more computers, cause the operations comprising:
a) receiving from a user's online computing device a computer inquiry requiring a service provider;
b) identifying any keywords in the inquiry and matching them with a plurality of service providers based on the keywords selected by the service providers, in a database of the service providers on the one or more computers;
c) transmitting the inquiry to the matched service providers without identifying the online users or the service providers to the user;
d) not receiving bids from the matched service providers within the specified time;
e) selecting a limited number of matched service provider bidders based on a selected criteria, including past bids, service provider's reviews and participation within the system, before providing at least one of the service providers and user with information to make a live contact between the service provider and the online user in order to provide the service; and
f) wherein the live contact is made by providing the user a clickable link which will engage a contact with the service provider.

### BRIEF DESCRIPTION OF THE DRAWINGS

FIG. 1 is a relationship of the system storage media of the invention.

FIG. 2 is a flowchart of the method of the present invention.

FIG. 3 is an example of a user trying to find a plumber.

### DETAILED DESCRIPTION OF THE INVENTION

While this invention is susceptible to embodiment in many different forms, there is shown in the drawings, and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

References throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitations thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “one or more computers” refers to any device with a processing capability. This includes, but is not limited to, desktops, laptops, smartphones, special purpose devices, control systems, servers in the data center, mobile devices, PDAs, etc. It assumes the one or more computers have Internet access to receive inquiries from a user. As used herein the term “app” denotes an application program executed only on the corresponding mobile or non-mobile device using a development language provided by an Operating System (OS) manufacturer.

As used herein, the term “non-transient machine readable storage medium” refers to any media that is involved in providing one or more instructions to a processor in a computer for execution this is non-transient. Computer readable media can be anything that a computer is able to read, such as, for example, disks, magnetic tape, CD-ROMs, any other optical medium, punch cards, paper tape, any other physical medium with patterns of holes, a RAM, PROM, an EPROM, a FLASH-EPROM, any other memory chip or cartridge or a carrier wave. It includes a single medium or multiple media, such as a centralized or distributed database, and/or associated caches and servers that store one or more sets of instructions. The term shall also include any medium that is capable of storing, encoding or carrying a set of instructions for execution by a processor, or that can cause a computer system to perform any one or more of the methods or operations disclosed herein.

As used herein, the term “user” refers to any person or entity which is using the system of the present invention to find a particular service by using an app or other means online to get a live response from a service provider. As used herein “service” refers to any service provided by a service provider, either a company or an individual.

As used herein, the term “online computing device” refers to any computer which has access to the internet. As used herein, the “internet” refers to any collection of networks using standard protocols. For example, the term includes a collection of interconnected (public and/or private) networks that are linked together by a set of standard protocols (such as TCP/IP, HTTP, FTP and XMPP) to form a global, distributed network. While this term is intended to refer to what is now commonly known as the Internet, it is also intended to encompass variations that may be made in the future, including changes and additions to existing standard protocols or integration with other media (e.g., television, radio, etc.). The term is also intended to encompass non-public networks such as private (e.g., corporate) Intranets. As used herein, the terms “World Wide Web” or “web” refer generally to both (i) a distributed collection of interlinked, user-viewable hypertext documents (commonly referred to as Web documents or Web pages) that are accessible via the Internet, and (ii) the client and server software components which provide user access to such documents using standardized internet protocols. Currently, the primary standard protocol for allowing applications to locate and acquire web documents is HTTP, and the web pages are encoded using HTML. However, the terms “web” and “World Wide Web” are intended to encompass future markup languages and transport protocols that may be used in place of (or in addition to) HTML, XMPP and HTTP.

As used herein, the term “website” refers to a computer system that serves informational content over a network using the standard protocols of the World Wide Web. Typically, a website corresponds to a particular internet domain name and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for website users.

As used herein, the term “in electronic communication” refers to electrical devices (e.g., computers, processors, etc.) that are configured to communicate with one another through direct or indirect signaling. For example, a conference bridge that is connected to a processor through a cable, wire or wireless, such that information can pass between the conference bridge and the processor, are in electronic communication with one another. Likewise, a computer configured to transmit (e.g., through cables, wires, infrared signals, telephone lines, etc.) information to another computer or device, is in electronic communication with the other computer or device.

As used herein, the term “transmitting” refers to the movement of information (e.g.; data) from one location to another (e.g., from one device to another) using any suitable means.

As used herein the term “computer inquiry” refers to one or more whole or partial words, characters, or strings of characters, photos, videos, or the like, designed to produce information related to finding a service provider. The inquiry can be by text, voice, picture, or video utilizing the computer. For example, the user can send a text “I need a plumber” or, optionally, a photo or video of the problem. This assumes the inquiry is on a messaging application, on a phone or computer application (i.e. a phone-to-phone messaging application), and not on an online search engine, such as Google®. The inquiry would go to a particular phone number or the like. The inquiry can contain such things as title, description, budget, timeline, or location where service is needed, and include one or more attachments such as pictures, videos, and the like.

As used herein, the term “service provider” refers to an individual, company, facility, or the like, which provides a service or benefit to one or more user. In one embodiment, they are experts in the field. Examples of service providers include professionals, consultants, product specialists, real estate agents, lawyers, accountants, doctors, salespersons, house painters, teachers, massage therapists, hotels, hospitals, plumbers, restaurants, bars, including individual connections for mutual interests, dating or the like, and combinations thereof.

As used herein, the term “keywords” refers to words, phrases, symbols, and/or slang, and any combination thereof that may: 1) have a single meaning related to any of the categories; 2) have multiple meanings where some meanings are related to more than one category; and/or, 3) have one or more meanings that are not related to any category.

As used herein, the term “matching” refers to coordinating users in need of a service with, or directing or guiding consumers to, one or more service providers in a live manner. These are the service providers that are capable of performing services for the consumers and responding within a limited time with a bid, according to consumer criteria. In other words, the term refers to coordinating consumers with a focused set of service provider options that match consumer criteria, as opposed to pairing up a given consumer with a specific service provider. It is understood, as will be described in more detail below, that certain embodiments of the present invention provide for consumers to choose the specific service providers that will perform the services for the consumers.

As used herein the term “database” refers to a data structure for storing information for use by the system and the computer.

As used herein the term “transmitting the inquiry” refers to the movement of information (e.g. data) from one location to another (e.g., from one device to another) using the application to transmit. It is done without identifying the user to service providers of the service providers to users and requires the response within an appropriate timeframe.

As used herein, the term “bid” refers to a flat amount of money paid to the system, in return for being given the information in order to contact the user live. It can be as little as $0.01. Each time the service provider is given a potential user, the service provider can decide if it is going to bid and, if so, how much. If bidding, the service provider answers the inquiry by offering to pay the system a certain amount. The system creates the bid money amount for pairing the service provider and user. If accepted, the service provider pays the bid amount f presented to the user, regardless of whether the user uses the service provider's service. For example, if a user is looking for a plumber in Raleigh, several Raleigh plumbers are sent information about the user's inquiry without including the user's contact information. Then each of the plumbers, if they want to try and get the user's business, can bid a dollar amount. The top three, or first three, five, or the like, plumbers are given to the user as a live contact. In one embodiment, contacts made through the phone, text, or video are allowed to connect free of charge regardless of location.

As used herein, the term “limited number” and “selected criteria” refers to limiting the number of service providers that will be given information for contacting the user, i.e. the number of live contacts to be given the user. “Selected criteria” refers to how the limited number is chosen but must include, as a criteria, a bid and within a time limit. This is a choice for the manager or owner of the system. While it can be done by any means, in one embodiment it is time based, e.g. done by selecting all the service providers who bid within a certain time. In another embodiment, the selected criteria is by bid amount, for example the top three bidders in bid amount, or any bidders above a certain amount. In one embodiment, the highest bidders (e.g. the three, four, or five highest bidders) are connected to the customer. In one embodiment, if no service providers bid or insufficient bids are made, the service providers can then bid for free, perhaps up to a limited amount. In another embodiment, the user can receive a complete list if no one bids.

As used herein, the term “information” refers to both information about the user and any service provider that can be utilized to make a live contact. It includes everything on a standard online profile for each, and also includes at least one way of contact in a live manner, e.g. phone, address, email, text and the like. In one embodiment it does not include a photo. In another embodiment, it provides some profile details, but not enough to make contact, such as just a state, just a city, or the like.

As used herein, the term “live contact” refers to real time contact of the user while, in one embodiment, it is by email. It can be by phone, text, or the like, or in any manner that the user is, or can be, put in direct live contact with one or more service providers. In one embodiment, a phone call (to any location on the globe) is automatically initiated to the service provider upon use of a click on a text link, icon, or map link. In one embodiment, the links actuate a text messaging function to the service providers, such as SMS or in-app text messaging. In another embodiment, the link opens up an email interface.

As used herein, the term “app” refers to any application, software, or program that can be run on any device, such as a desktop computer, a mobile computer, a smartphone, or the Ike that can be utilized to send the inquiry to the one or more computers.

As used herein, the term “online profile” refers to text, image, sound, video, or animated representations about a particular entity, e.g., a human being. For example, profile information, including textual information such as name, address, employment, spoken language, buying preferences, age, hobbies, etc. Profile information also includes information typically found on social media or business networking sites, such as, for example, LinkedIn® or Facebook®.

### DRAWINGS

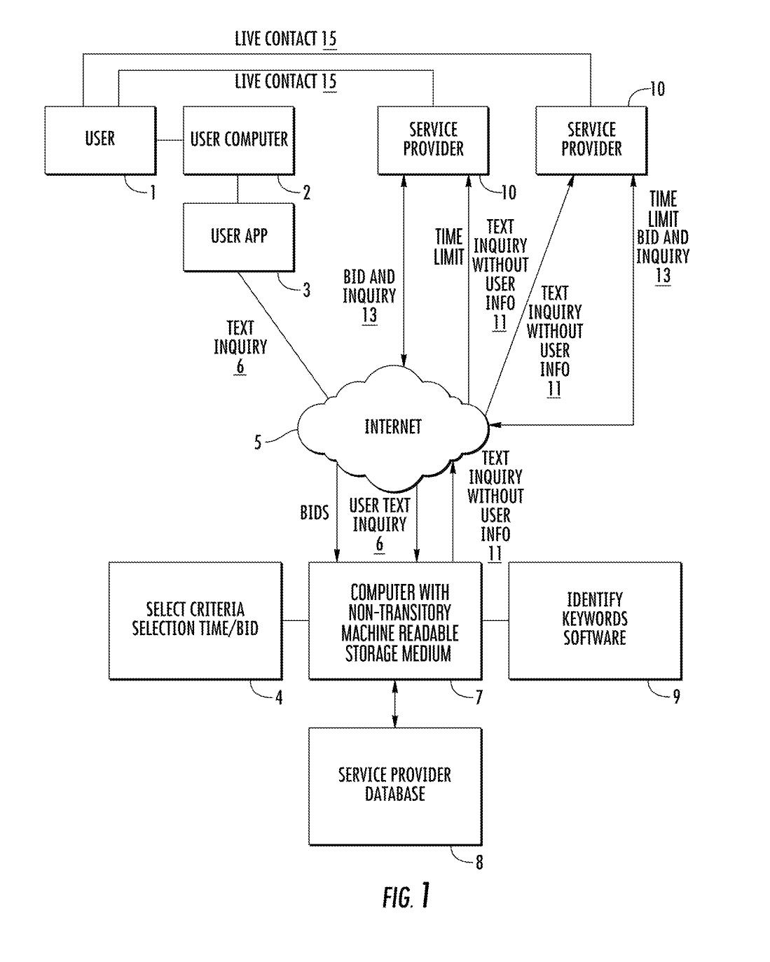

Now referring to the drawings, FIG. 1 is a relationship of the system and storage media of the invention. In this embodiment, there is a user 1 with a user computer 2 running a user app 3 for finding a service provider using the system of the present invention. The user computer 2 is connected to the internet 5 using the user app 3, and the user 1 types a text inquiry 6 in user app 3 which is then sent to the internet 5. The user text inquiry 6 is delivered to the one or more computers 7 equipped with access to non-transient machine readable storage medium and selection criteria 4, a service provider database 8 a software that allows it to identify keywords 9 in the text inquiry 6 in order to determine which service provider 10 to send the inquiry without the user info 11. The text inquiry without user info 11 is sent to service providers for consideration. If the service provider 10 is interested in performing service after consideration for the unidentified user 1, then the service provider 10 sends bid 13 to the computer 7 (through the internet 5) wherein the highest and/or quickest bids entitle the service provider 10 to see who the user 1 is and get user information for live contact 15. The bid is not for the service, but rather bid is to obtain basic user information and be able to communicate with the user 1 using text messaging and/or phone call based on the preference of the user 1.

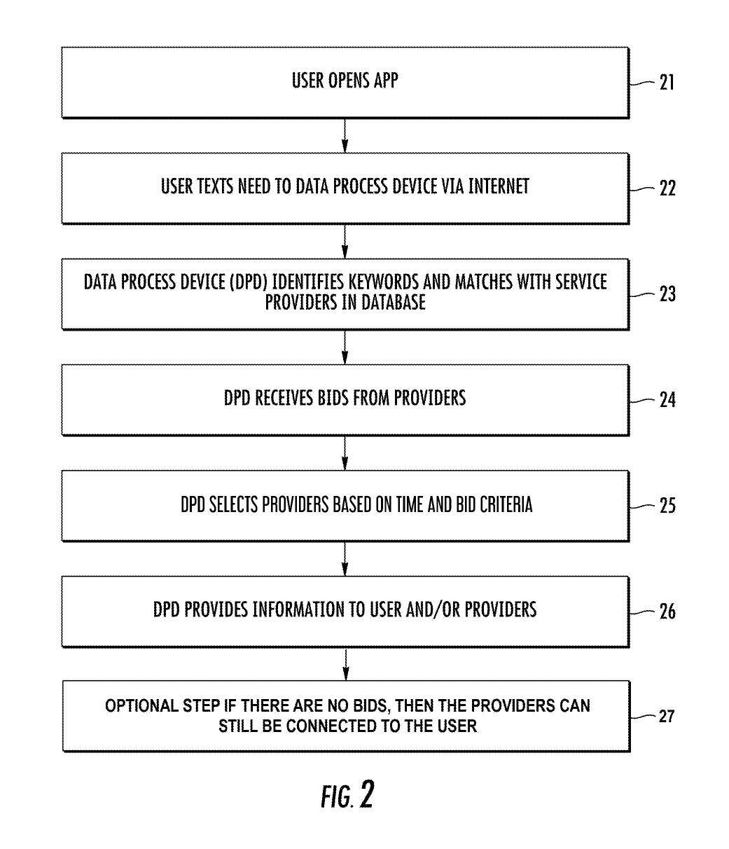

FIG. 2 is the method of using the system of the present invention. In this figure, the user opens up the app 21 and the user utilizes the app to text a need to a data process device in a computer via the internet 22. The data process device (DPD) identifies keywords in the text and matches those keywords with service providers in a data base 23. Next, the interested service providers bid 24 on getting to see the user's information and the DPD applies the criteria to decide who gets the information 25. The DPD then provides the information to the service provider who can make a live contact with the user 26. In an optional embodiment, if no providers bid 27 then providers can be connected to the user anyway. In one embodiment, the user is given a list of service providers.

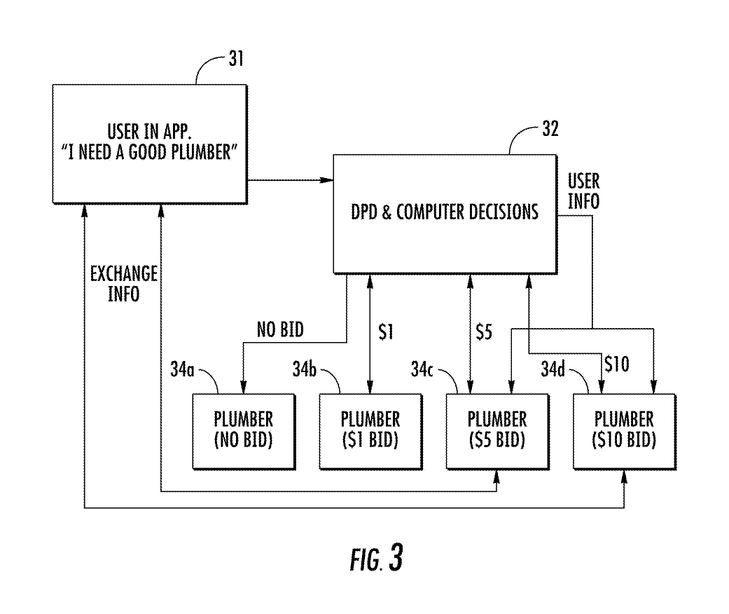

FIG. 3 is a specific example of the use of the present invention. In this figure, user utilizes the app and types text “I need a good plumber” 31 and texts it to the DPD and computer, which, utilizing software, decides a plumber is needed 32. The computer notifies four plumbers 34a, 34b, 34c and 34d, and gives them info about the need without the user's identity. Plumber 34a decides not to bid, while plumbers 34b, 34c and 34d bid $1, $5 and $10 respectively. The computer 32 decides to take the top two bids monetarily (or the first two in the door) and sends plumbers 34c and 34d the user's information for live exchange of information and possible servicing of the user. The user then has a live contact with two of the plumbers to discuss the details and decides if the plumber should be hired or not. The process can be repeated if the user is not satisfied with the contacts made.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A method performed by a non-transitory machine storage medium of one or more computers comprising:
a) receiving from a user's online computing device a computer inquiry containing unstructured data requiring a service provider;
b) identifying any keywords or key phrases in the inquiry and matching them with a plurality of service providers based on the keywords or key phrases selected by the service providers in a database of the service providers on the one or more computers;
c) transmitting the inquiry to the matched service providers without identifying the online user, or the service provider to the user;
d) the computer receiving bids from the matched service providers, the computer programmed to only accept bids within a specified time, the bids from service providers interested in providing a service to the online user; and
e) selecting a limited number of matched service provider bidders based on a selected criteria, including the bid amount, before providing the selected bidders with information to make a live contact with the online user in order to provide the service.

2. The method according to claim 1 wherein the inquiry comes from an app or a web interface on the online user's computing device, which sends the inquiry to the computer readable medium.

3. The method according to claim 1 wherein the user receives response through text messages from service providers.

4. The method according to claim 1 wherein the user receives response by phone call.

5. The method according to claim 1 wherein the selected criteria is a selected number of received bids within the specified time.

6. The method according to claim 1 wherein the information includes an online profile with live contact information.

7. The method according to claim 1 wherein if no bids are received, the user is connected to one or more service providers.

8. The method according to claim 1 wherein a photo of a problem is included in the transmitted inquiry.

9. The method according to claim 1 wherein a video of a problem is included in the transmitted inquiry.

10. A non-transitory computer storage medium encoded with a computer program, the program comprising instructions that, when executed by a data processing apparatus, cause the data processing apparatus to perform operations comprising:
a) receiving from a user's online computing device a computer inquiry containing unstructured data requiring a service provider;
b) identifying any keywords or key phrases in the inquiry and matching them with a plurality of service providers based on the keywords or key phrases selected by the service providers in a database of the service providers on the one or more computers;
c) transmitting the inquiry to the matched service providers without identifying the online user or the service providers to the user;
d) receiving bids from the matched service providers within a specified time, the bids from service providers interested in providing a service to the online user; and
e) selecting a limited number of matched service provider bidders based on a selected criteria, including the bid, before providing the selected bidders with information to contact the online user in order to provide the service.

11. The storage medium according to claim 10 wherein the text inquiry comes from an app or web interface on the online user's computing device which sends the text inquiry to the computer readable medium.

12. The storage medium according to claim 10 wherein the user receives response through text messages from service providers.

13. The storage medium according to claim 10 wherein the user receives response by phone call.

14. The storage medium according to claim 10 wherein the selected criteria is a selected number of received bids within the specified time.

15. The storage medium according to claim 10 wherein the information includes an online profile with live contact information.

16. The storage medium according to claim 10 wherein if no bids are received, the user is connected to one or more service providers.

17. An application according to claim 10 on an online user's computing device which sends a text inquiry to the computer readable medium and receives live contact information from the computer readable medium regarding one or more service providers.

18. The storage media according to claim 10 in which further comprises delivery of one or more providers' contact information to the user when no providers bids on the service.

19. A system comprising one or more computers and a non-transient machine readable storage medium coupled to the one or more computers, the medium having encoded therein instructions which, when executed by the one or more computers, cause the operations in the computers comprising:
a) receiving from a user's online computing device a computer inquiry containing unstructured data, requiring a service provider;
b) identifying any keywords in the inquiry and matching them with a plurality of service providers based on the keywords or key phrases selected by the service provider, in a database of the service providers on the one or more computers;
c) transmitting the inquiry to the matched service providers without identifying the online user or the service providers to the user;
d) receiving bids from the matched service providers interested in providing a service to the online user;
e) selecting a limited number of matched service provider bidders based on a selected criteria, including the bid, before providing at least one of the selected bidders and user with information to make a live contact between the selected bidder and the online user in order to provide the service; and
f) wherein the live contact is made by providing the user a clickable link/image which will engage a contact with the service provider.

20. The system according to claim 19 wherein the clickable link/image consists of a connection to a service provider from the group consisting of:
a) a phone call to the service provider anywhere in the world;
b) a text message to the service provider; and
c) an email interface.
